(19) United States
(12) Patent Application Publication
(10) Pub. No.: US 2021/0006198 A1
(43) Pub. Date: Jan. 7, 2021

(54) AUXILIARY SOLAR PANEL

(71) Applicant: LOOK FOR THE POWER, LLC, Irmo, SC (US)

(72) Inventor: John A. Saavedra, Irmo, SC (US)

(73) Assignee: LOOK FOR THE POWER, LLC, Irmo, SC (US)

(21) Appl. No.: 17/026,934

(22) Filed: Sep. 21, 2020

Related U.S. Application Data
(63) Continuation of application No. 15/994,199, filed on May 31, 2018.

(51) Int. Cl. H02S 20/24; H02S 20/10; H02S 20/30

(52) U.S. Cl. CPC H02S 20/24; H02S 20/30; H02S 20/10

(57) ABSTRACT

A solar array may have a primary solar panel attached to a supporting structure and an auxiliary solar panel attached at an angle to the primary panel. The primary solar panel may be positioned to collect daily solar radiation and the auxiliary solar panel may be positioned relative the primary panel to collect daily solar radiation. The daily solar radiation collected by the primary solar panel may be peak annualized daily solar radiation and the daily solar radiation collected by the auxiliary solar panel may be off-peak solar radiation.

### CROSS-REFERENCE TO RELATED PATENT APPLICATIONS

This patent application is a continuation of the non-provisional application Ser. No. 15/994,199 filed May 31, 2018, in which the entire application is herein incorporated by reference in its entirety.

### TECHNICAL FIELD AND BACKGROUND OF THE INVENTION

The invention relates generally to the field of power generation and more particularly to the field of solar power generation. The present invention is an auxiliary solar panel which is connected at an angle to a primary solar panel. The present invention may permit the collection of solar power beyond the capabilities of the primary solar panel. As used throughout this application the term solar panel shall refer to one or more photovoltaic cells operably linked together.

Global demand for energy continues to climb, especially in developing countries. An ever-increasing amount of this demand is met by renewable, sustainable sources such as wind and solar. Both on a utility and individual level, solar power enjoys steady growth, with more projected as the manufacturing and production costs of photovoltaic solar panels fall.

Solar power offers many advantages in the generation of electricity. It has zero raw fuel costs, unlimited supply and minimal environmental issues such as transport, storage, or pollution. Solar power is available everywhere, even on the moon but to get the most out of a solar panel or solar array, it has to be oriented directly at the sun's radiant energy.

Photovoltaic solar panels absorb sunlight as a source of energy to generate electric electricity. A photovoltaic (PV) module is a packaged, connected assembly of photovoltaic solar cells. Photovoltaic modules constitute the photovoltaic array of a photovoltaic system that generates and supplies solar electricity in commercial and residential applications.

Photovoltaic arrays may be positioned on roof tops of buildings, in open fields, above a body of water, atop utility poles, and in other locations which have exposure to the sun's rays.

PV arrays must be mounted on a stable, durable structure that can support the array and withstand wind, rain, hail, and corrosion over decades. For optimal performance, these structures tilt the PV array at a fixed angle determined by the local latitude, orientation of the structure, and electrical load requirements. To obtain the highest annual energy output, modules in the northern hemisphere are pointed due south and inclined at an angle equal to the local latitude.

Existing PV solar panels operate most efficiently when the angle of incidence of the sun is zero degrees. A solar cell performs the best when its surface is perpendicular to the sun's rays, which change continuously over the course of the day and season. Said another way, the PV panel is horizontal along its east-west axis but inclined along its north-south axis.

Empirical data, historical precedent, current practice, and common sense dictate the placement and orientation of PV solar panels. All of these sources clearly show that maximum performance of these panels occurs under a clear sky when the sun is directly overhead at high noon local time, on a panel whose east-west axis is horizontal, at the Earth's equator. Anything else represents compromised performance. That is, clouds, haze, angle of latitude above the tropics, and time of day before or after high noon local time will show degraded performance. In locations outside the Tropics of Cancer and Capricorn (49 of 50 US states), the sun is never directly overhead. In these locations, optimal output is obtained when a panel's north-south axis is offset by the location's latitude, and its east-west axis is completely horizontal.

There are several methods of actively moving a solar panel to “follow” the sun in its daily arc across the sky. They must be designed and built to operate in a wide range of unfavorable, challenging conditions—snow, ice, sleet, hail, thunderstorm, hurricane, severe cold, tropical heat and humidity, air pollution, and wide daily temperature fluctuations from solar radiant heat. These methods all have several things in common: they require frequent monitoring, maintenance, adjustment, and repair; they are complex, requiring sensors and activators, often computer-controlled; they require an energy source, usually external, including batteries, when the sun is not shining; they are impractical for roof-mounted PV solar panel installations; they are expensive; and they are often sited in remote locations, adding to maintenance costs. For these reasons and others, solar tracking PV solar panels are seldom used. They are the exception, rather than the rule.

Studies have shown that the performance of a given PV solar panel is degraded by 30% at an angle of incidence of 45°, which may occur before 9:00 AM or 4:00 PM local time.

Though solar panels are positioned to optimize annual solar ray collection, they are not able to collect all of the rays in a given area. Solar panels, even panels which are inclined to optimize collection, will not collect all rays, particularly when the sun is rising or setting or during particular times of the year. Thus, there is a need in the art to be able to collect more energy from the sun.

### SUMMARY OF THE INVENTION

It is therefore an object of the present invention to provide a solar array that increases performance of the array throughout all daylight hours.

It is a further object of the present invention to increase the performance of existing PV solar panels and arrays during all daylight hours, but especially during morning and evening hours, far beyond current practice or skill in the art, without adding additional monitoring, maintenance, adjustment, or repair. The invention disclosed herein is simple in the extreme, has low cost, and functions without an external energy source.

These and other objects and advantages of the invention are achieved by providing a solar array having a primary solar panel attached to a supporting structure and positioned to collect daily solar radiation, and an auxiliary solar panel attached at an angle to the primary panel and positioned relative the primary panel to collect daily solar radiation. The primary solar panel and the auxiliary solar panel are operably connectable to a power grid, a power storage device, and/or a load.

According to another embodiment of the invention, the daily solar radiation collected by the primary solar panel comprises peak annualized daily solar radiation and wherein the daily solar radiation collected by the auxiliary solar panel comprises off-peak solar radiation. As used herein, the term “peak annualized daily solar radiation” refers to the optimized positioning of a fixed solar panel based on latitudinal location of the solar panel, the panel being angled and positioned to optimize collection by a photovoltaic cell over the course of a year. As used herein, the term “off peak solar radiation” refers to positioning other than the position considered necessary to collect peak annualized daily solar radiation.

According to another embodiment of the invention, the daily solar radiation collected by the primary solar panel consists of peak annualized daily solar radiation and wherein the daily solar radiation collected by the auxiliary solar panel consists of off-peak solar radiation.

According to another embodiment of the invention, the auxiliary solar panel is attached at an outer edge of the primary solar panel.

According to another embodiment of the invention, the angle between the primary solar panel and the auxiliary solar panel is adjustable.

According to another embodiment of the invention, the auxiliary solar panel comprises a plurality of solar panels.

According to another embodiment of the invention, the plurality of solar panels of the auxiliary solar panel is attached to an outer edge of the primary solar panel.

According to another embodiment of the invention, the solar array further includes a secondary auxiliary solar panel attached to a distal end of the auxiliary solar panel operably connectable to a power grid, a power storage device, and/or a load.

According to another embodiment of the invention, surface area of a top surface of the primary panel is twice as large as the surface area of the auxiliary panel.

According to another embodiment of the invention, the angle between the auxiliary solar panel and the primary solar panel is 90 degrees relative a top surface of the primary panel.

According to another embodiment of the invention, the angle between the auxiliary solar panel and the primary solar panel is between 90 degrees and 135 degrees relative a top surface of the primary panel.

According to another embodiment of the invention, the angle between the auxiliary solar panel and the primary solar panel is between 90 degrees and 45 degrees relative a top surface of the primary panel.

According to another embodiment of the invention, the supporting structure is a rack.

According to another embodiment of the invention, the supporting structure is a vertical pole.

According to another embodiment of the invention, the auxiliary solar panel has photovoltaic cells on both a top surface and a bottom surface.

According to another embodiment of the invention, the auxiliary solar panel is actually two separate solar panels joined together, back-to-back, so that the photovoltaic cells of both panels face outward and the reverse of both panels face each other.

According to another embodiment of the invention, the solar array may include a plurality of solar panels attached to a vertical support and positioned about the vertical support structure to collect daily solar radiation. The term about refers to the distribution around the vertical support. The daily solar radiation collected by the array may comprise both peak annualized solar radiation and off-peak solar radiation.

According to another aspect of the invention, each one of the plurality of solar panels is operably connectable to a power grid, a power storage device, and/or a load.

According to another aspect of the invention, the vertical support structure may be one or more of a utility pole, an antenna, and/or a building structure which has a substantially vertical design relative horizontal ground.

According to another aspect of the invention, each one of the plurality of solar panels has photovoltaic cells on both a top surface and a bottom surface.

According to another aspect of the invention, the solar array is positioned adjacent to a field of solar arrays positioned to collect peak annualized solar radiation.

According to another embodiment of the invention, a solar array may include a plurality of solar panels, each joined in a back-to-back orientation with another one of the plurality of solar panels wherein the plurality of solar panels are positioned in a vertical orientation relative horizontal ground. According to such an embodiment, each of the panels may be attached to a support structure and positioned to face either due east or due west.

According to another embodiment of the invention, each one of the plurality of solar panels may be operably connectable to a power grid, a power storage device, and/or a load.

According to another embodiment of the invention, the vertical support structure is one or more of a utility pole, an antenna, and/or a building structure which has a substantially vertical design relative horizontal ground. Further, the solar array may be positioned adjacent to a field of solar arrays positioned to collect peak annualized solar radiation.

According to another aspect of the invention each of the solar panels may be attached to a support structure and positioned to face either due east or due west.

According to another embodiment of the invention, the solar panels may face substantially east and west.

According to another embodiment of the invention, the solar panels may be positioned to form faces of a three dimensional object. Further, the three dimensional object is a sphere or an ellipsoid.

According to another aspect of the invention, the solar panels comprise substantially all of a surface area of the three dimensional object.

### BRIEF DESCRIPTION OF THE DRAWING FIGURES

The present invention is best understood when the following detailed description of the invention is read with reference to the accompanying drawings, in which:

FIG. 1 is a perspective view of the invention;

FIG. 2 is a perspective view of the invention;

FIG. 3 is a perspective view of the invention;

FIG. 4A is a side view of the invention;

FIG. 4B is a side view of the invention;

FIG. 4C is a side view of the invention;

FIG. 5 is a perspective environmental view of the invention;

FIG. 6 is a perspective environmental view of the invention;

FIG. 7 is a perspective environmental view of the invention;

FIG. 8A is a partially exploded view of the invention;

FIG. 8B is a partially exploded view of the invention;

FIG. 9A is a side view of another embodiment of the invention;

FIG. 9B is a side view of another embodiment of the invention;

FIG. 10 is an environmental view of another embodiment of the invention; and

FIG. 11 is an environmental view of another embodiment of the invention.

### DETAILED DESCRIPTION OF THE PREFERRED EMBODIMENT

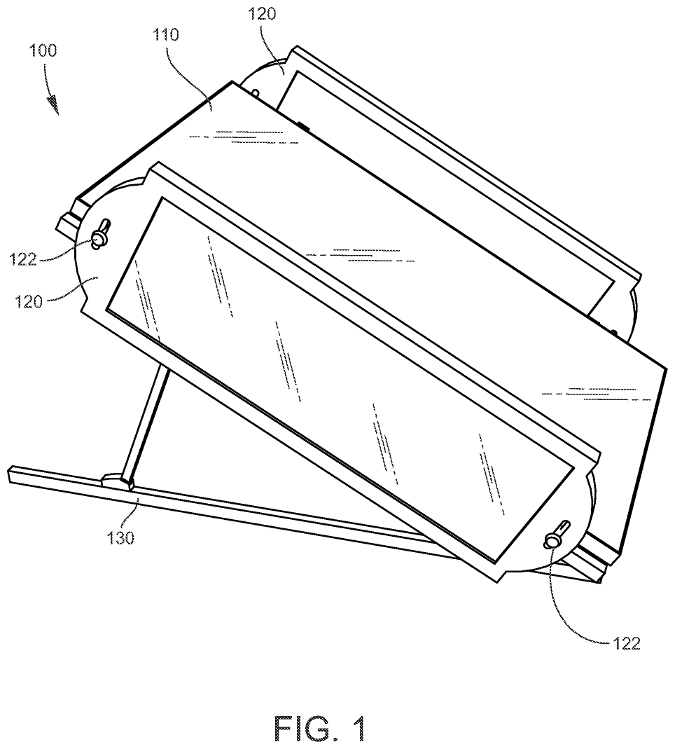

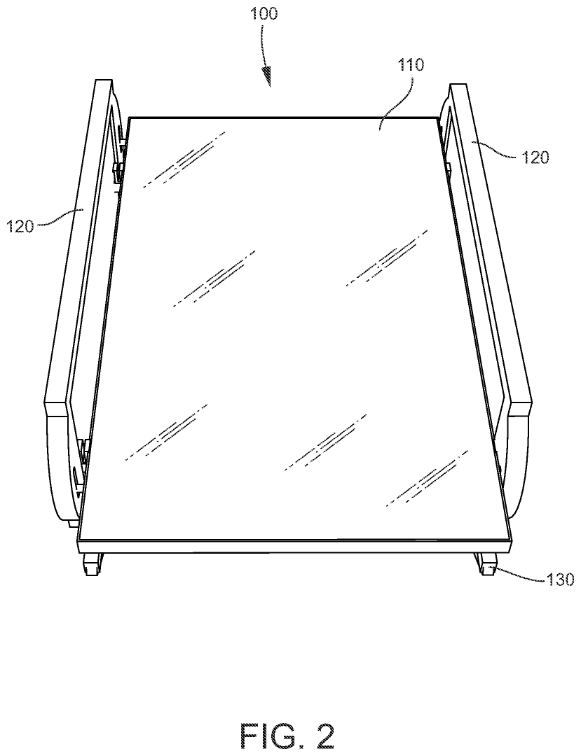

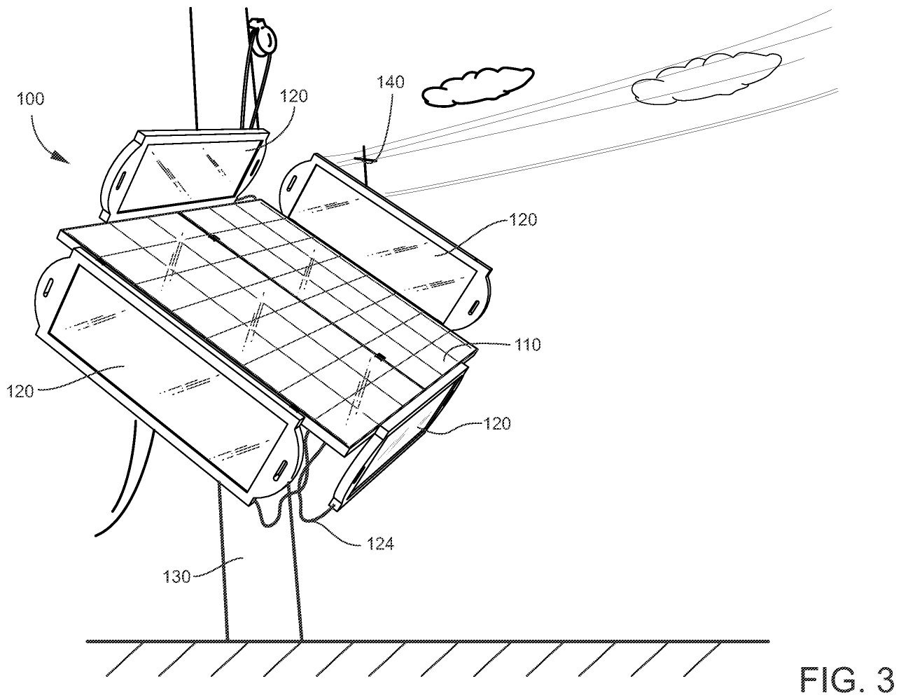

Referring now to the drawings, FIGS. 1, 2 and 3 show the solar array 100 of the present invention where a primary panel 110 is attached to a support structure 130. As shown, the support structure is a rack. Auxiliary panels 120 are attached to the primary panel 110 at an angle to the primary panel 120. As shown in FIGS. 1, 2 and 3, the auxiliary panels 120 are attached at an angle of 90 degrees relative a top planar surface of the primary panel. The auxiliary panels 120 may have photovoltaic cells on both of the top and bottom planar surfaces. FIGS. 1 and 2 show a pair of auxiliary panels 120 attached primary panel 110. FIG. 3 shows four auxiliary panels 120 attached to the primary panel 110. According to the present invention, one or more auxiliary panels 120 may be attached to the primary panel 110. The primary panel 110 is positioned on the support structure 130 at a fixed angle in order to maximize the collection of daily solar radiation by the primary panel 110. However, due to the fixed nature of the primary panel 110, the primary panel 110 will not collect all local solar radiation. Auxiliary panels 120 will collect solar radiation that is not collected by the primary panel 110. As shown in FIG. 3, appropriate wiring 124 may be used to connect the auxiliary panels 120 to the primary panels 110 and to a power grid 140, a power storage device (not shown), and/or a load (not shown).

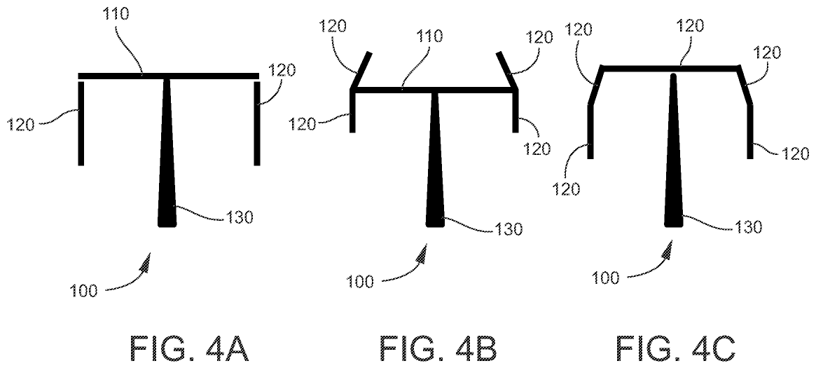

Referring now to FIGS. 4A, 4B, and 4C, the support structure 130 may be a vertical pole as shown. The primary panel 110 is attached to the support structure 130. Auxiliary panels 120 are attached to the primary panel 110.

As shown in FIG. 4A, the auxiliary panels 120 are attached at a 90 degree angle relative a top surface of the primary panel 110.

As shown in FIG. 4B, a pair of auxiliary panels 120 are attached at a 90 degree angle relative a top surface of the primary panel 110 and in a downward direction relative the primary panel 110 while another pair of auxiliary panels 120 are attached at an acute angle relative a top surface of the primary panel 110 in an upward direction to the primary panel 110.

As shown in FIG. 4C, a first pair of auxiliary panels 120 is attached at an obtuse angle relative a top surface of the primary panel 110 and in a downward direction to the primary panel 110. A second pair of auxiliary panels 120 is attached to the first pair of auxiliary panels 120 at a distal end of the first pair of auxiliary panels.

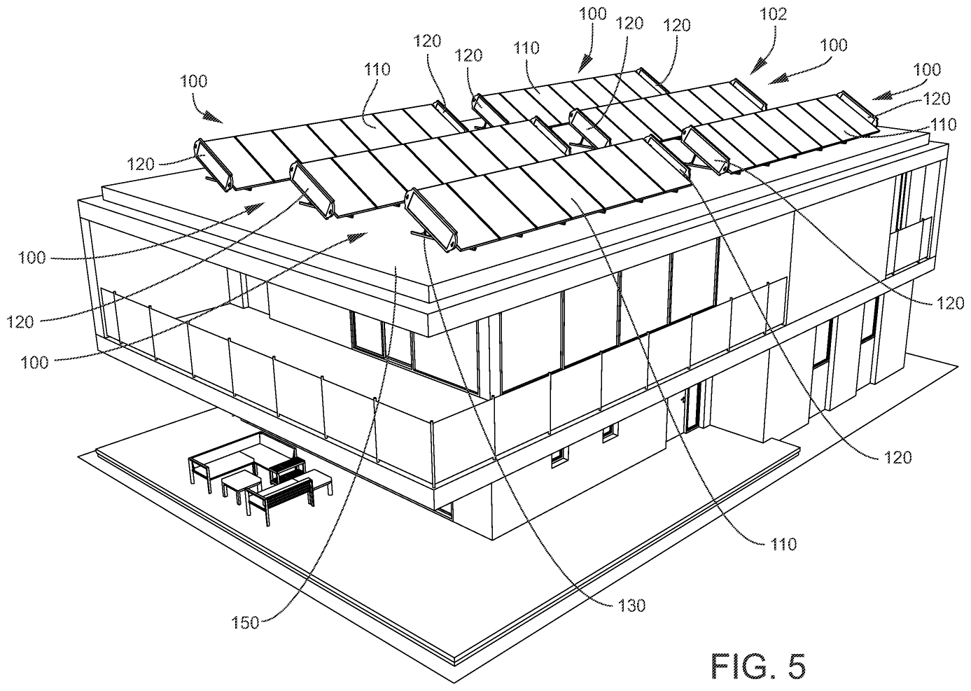

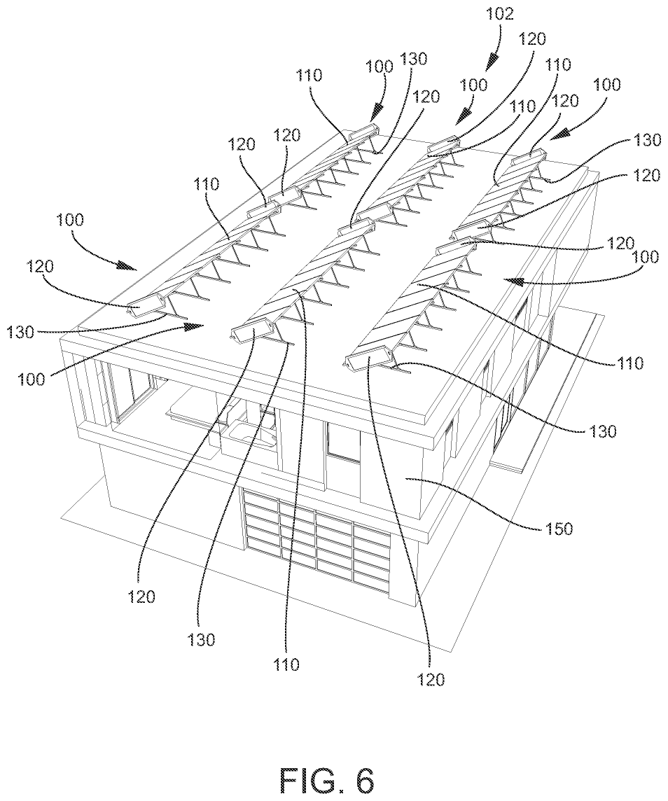

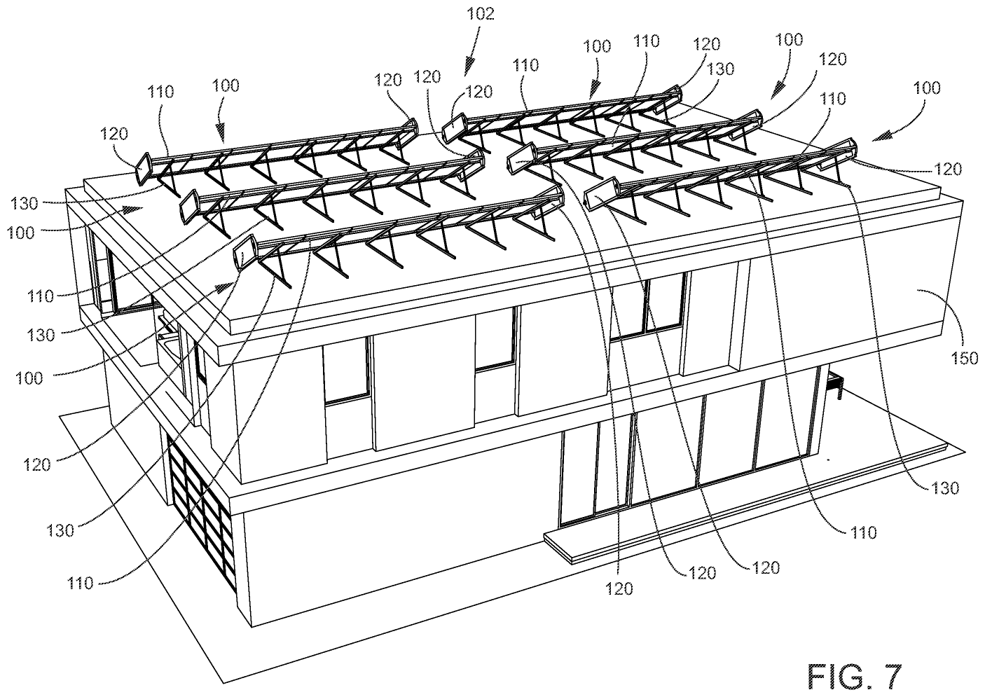

Referring now to FIGS. 5, 6, and 7, a plurality of solar arrays 102 is shown. Each solar array 100 includes a support structure 130 which is attached to a surface of a building 150. Primary panels 110 are attached to the support structure 130. Auxiliary panels 120 are attached primary panels 110 at an angle to the primary panel 110.

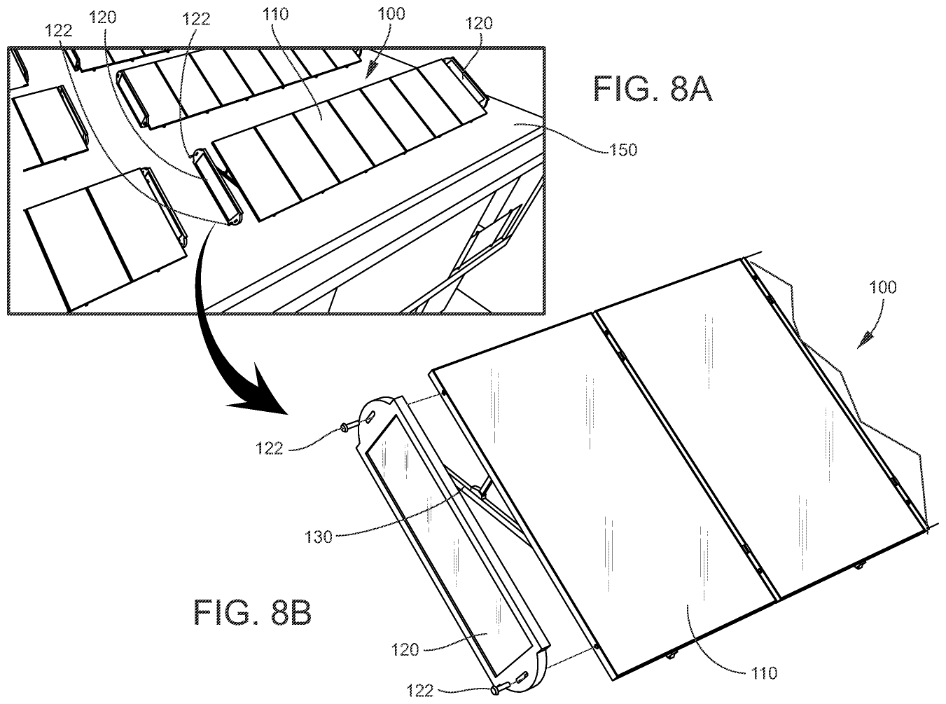

Referring now to FIGS. 8A and 8B, the auxiliary panels 120 may be attached to the primary panels 110 via an attachment means including bolts 122 as shown. Such means may include welds, bolts, rivets, glue, magnets, hinges, gears, clasps, and other attachment means which may be fixed, removable, and/or movable.

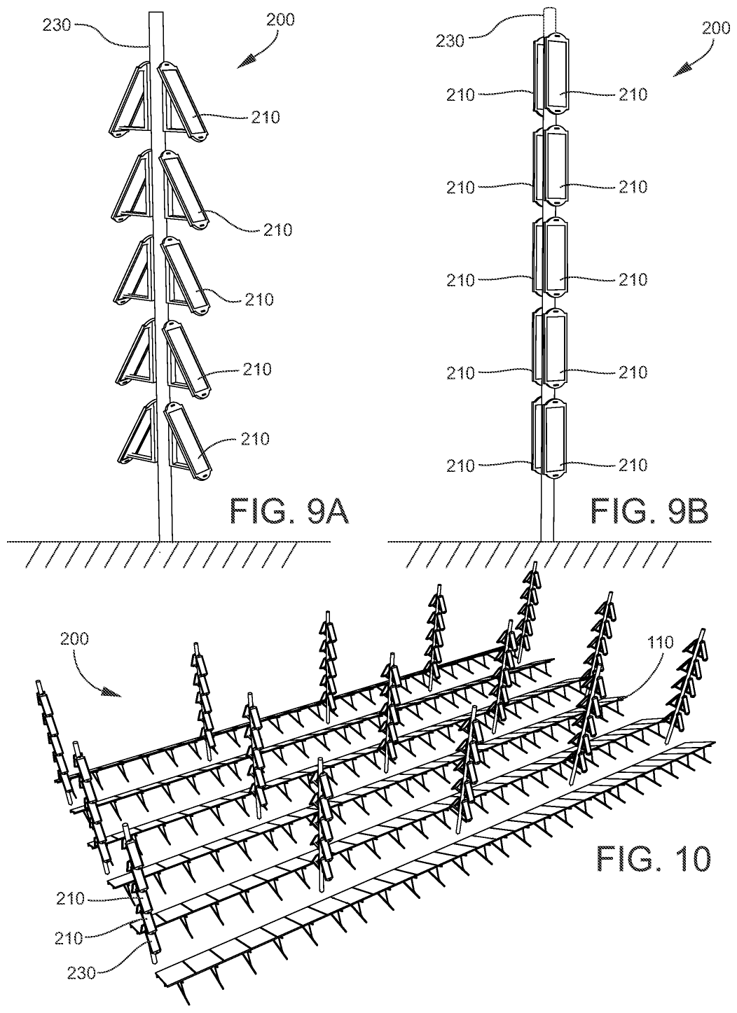

Referring now to FIGS. 9A, 9B, and 10, according to another embodiment of the invention 200, a plurality of solar panels 210 may be attached to a vertical pole 230. The panels 210 are be attached to the pole at an angle to the pole 230. Alternatively, the panel 210 may be completely vertical, relative to horizontal ground, and attached to a surface of the pole 230. As shown in FIG. 10, the panels 210 and pole 230 of the invention 200 may be utilized in association with an array of solar panels 110 which have been oriented in order to collect peak annualized daily solar radiation. The pole 230 may be a utility pole, an antenna, and/or another building structure which has a substantially vertical design relative horizontal ground. Alternatively, the pole 230 may be a moveable structure such as street sign, a utility trailer, or an automobile.

According to one aspect of the invention, 200, the panels 210 may have photovoltaic cells on both a front and a rear surface of the panels 210. Further, the panels may be oriented such that one surface faces an easterly direction and the other surface faces the westerly direction. Alternatively, the panels could be positioned about the pole such that one panel 210 faces east and another panel, on the opposite side of the pole, faces west.

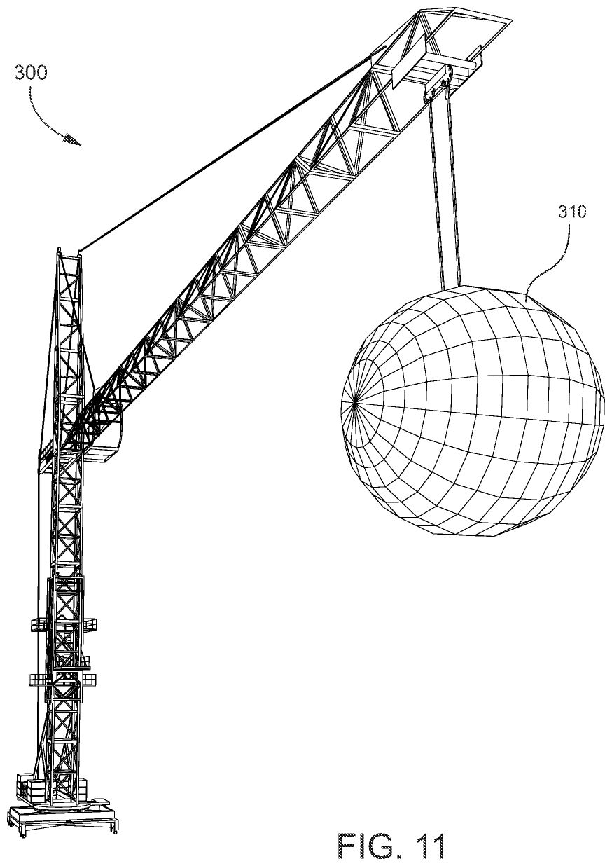

Referring to FIG. 11, according to another embodiment of the invention 300, the support structure may be overhead and the solar array having a plurality of solar panels 310 may hang from the support structure or otherwise be positioned below the support structure.

According to another embodiment of the invention 300, the solar array may have a three dimensional shape such as a sphere or an ellipsoid shape. The solar panels 310 may form the surface faces of the three dimensional shape and may completely cover the or substantially cover the three dimensional shape.

The foregoing has described a solar array 100 having a primary solar panel attached to a supporting structure 130 and an auxiliary solar panel 120 attached at an angle to the primary panel 110. It has also described an embodiment 200 having panels 210 attached to a vertical support 230 and a suspended embodiment 300. While specific embodiments of the present invention have been described, it will be apparent to those skilled in the art that various modifications thereto can be made without departing from the spirit and scope of the invention. Accordingly, the foregoing description of the invention and the best mode for practicing the invention are provided for the purpose of illustration only and not for the purpose of limitation.

What is claimed is:

1. A solar array comprising:
a primary solar panel fixedly attached to a supporting structure at a fixed angle relative to the supporting structure and positioned to collect peak annualized daily solar radiation, the supporting structure at least a portion of which is permanently mounted in the ground;
an auxiliary solar panel fixedly attached to the primary panel such that an angle between a plane defined by the auxiliary solar panel and a top surface of the primary panel measures between 45 degrees and 135 degrees and such that the auxiliary solar panel is positioned relative the primary panel to collect off-peak daily solar radiation, and
wherein the primary solar panel and the auxiliary solar panel are operably connectable to a power grid, a power storage device, and/or a load.

2. The solar array of claim 1 wherein the auxiliary solar panel is attached at an outer edge of the primary solar panel.

3. The solar array of claim 1 wherein a degree of the angle between the primary solar panel and the auxiliary solar panel is adjustable.

4. The solar array of claim 1 wherein the auxiliary solar panel comprises a plurality of solar panels.

5. The solar array of claim 6 where each of the plurality of solar panels of the auxiliary solar panel is attached to an outer edge of the primary solar panel.

6. The solar array of claim 6 further comprising a secondary auxiliary solar panel attached to a distal end of the auxiliary solar panel operably connectable to a power grid, a power storage device, and/or a load.

7. The solar array of claim 1 wherein a surface area of a top surface of the primary panel is twice as large as the surface area of the auxiliary panel.

8. The solar array of claim 1 wherein the supporting structure is a rack.

9. The solar array of claim 1 wherein the supporting structure is a vertical pole.

10. The solar array of claim 1 wherein the auxiliary solar panel is attached only to an outer edge of the primary solar panel.

11. The solar array of claim 1 wherein the auxiliary solar panel is attached to the supporting structure.

12. The solar array of claim 1 wherein the primary panel is installed in the northern hemisphere with a North-South axis of the primary panel facing south at an angle corresponding to the local latitude, and an East-West axis of the primary panel generally horizontal.
